(19) United States
(12) Patent Application Publication
(10) Pub. No.: US 2009/0089541 A1
(43) Pub. Date: Apr. 2, 2009

(54) MULTIPROCESSING DEVICE AND INFORMATION PROCESSING DEVICE

(76) Inventor: Shinji Yamamoto, Osaka (JP)

Correspondence Address: MCDERMOTT WILL & EMERY LLP, 600 13TH STREET, NW, WASHINGTON, DC, 20005-3096, US

(21) Appl. No.: 12/236,936

(22) Filed: Sep. 24, 2008

(30) Foreign Application Priority Data
Sep. 27, 2007 (JP) 2007-251024

(51) Int. Cl. G06F 15/76; G06F 9/30

(52) U.S. Cl. 712/29; 712/E09.016

(57) ABSTRACT

Instructions executed by a plurality of processors including a specific processor and the other processors connected to the specific processor are stored in an instruction storage memory. The instructions stored in the instruction storage memory are transferred to and retained in an instruction execution memory, and when an instruction is executed by one of the plurality of processors, a required instruction is retrieved by the processor. A leading address of a position where the required instruction of the other processors is retained in the instruction execution memory is stored in an address storage memory. A memory control circuit coordinates access to the instruction execution memory by the plurality of processors and controls access to the address storage memory by the specific processor.

### BACKGROUND OF THE INVENTION

1. Field of the Invention

The present invention relates to a technology which enables a processor provided in a multiprocessing device to be activated with a higher degree of freedom and achieves the reduction of an area and power consumption in the processor, and an information processing device provided with the multiprocessing device.

2. Description of the Related Art

In recent years, functions and performance levels of various information processing devices, in which a processor is used, are significantly improving. In order to further improve the functions and performance levels, a higher processing speed is demanded in the processor. It is effective to increase an operation frequency in order to increase the processing speed of the processor; however, there are limitations to the improvement of the operation frequency. Therefore, a plurality of processors are disposed in parallel and caused to execute their processing in parallel as a solution to this problem. Further, there is a strong request for the reduction of power consumption in the information processing device, and it is requested that a mobile device be reduced in size. In order to respond to these requests, for example, the number of parts in the device is reduced, and circuits are efficiently utilized. In a multiprocessing device, a memory in which instructions executed by processors are stored is shared by the processors, and the instructions are loaded into memories of the respective processors when the system is powered on or restarted, so that the number of memories in which instructions are stored is reduced to one from a plural number.

FIG. 7 illustrates a conventional technology wherein the reduction of memories was realized. A multiprocessing system recited therein comprises two processors, which are a first processor 21 and a second processor 22. The first processor 21 and the second processor 22 are connected to each other via an inter-processor interface circuit 23 so that data can be transmitted and received therebetween. A ROM (Read Only Memory) 24 stores therein instructions executed by both of the first and second processors 21 and 22, that is, the ROM 24 is shared by both the processors. The ROM 24 and a first RAM (Random Access Memory) 25 are connected to the first processor 21. The first processor 21 can write and read data with respect to the ROM 24 and the first RAM 25. A second RAM 26 is connected to the second processor 22. The second processor 22 can write and read data with respect to the second RAM 26. Under the control by a memory-write control circuit 27 provided on the second-processor-22 side, the second processor 22 writes data transmitted from the first processor 21 via the inter-processor interface circuit 23 in the second RAM 26. The memory-write control circuit 27 can provide control so that data can be written in the second RAM 26 even during the halt of the second processor 22. The second processor 22 is provided with a terminal RESET which receives a reset control from the first processor 21. A program executed by the first processor 21 is stored in the ROM 24. A program executed by the second processor 22 is, at first, stored in the ROM 24, and then transferred from the ROM 24 to the second RAM 26 when the system is activated. The first processor 21 transmits a boot program and a main program of the second processor 22 to the second RAM 26, and the second processor 22 reads the instruction from the second RAM 26 and executes the program. An example of the technology thus constituted is recited in No. 2006-202200 of the Japanese Patent Publication Laid-Open.

In the conventional technology, it was necessary to prepare individual instruction execution memories (RAM) where the instructions executed by a plurality of processors are stored. In the case where the number of the processors is increased, it is necessary to increase the number of the instruction execution memories (RAM) in a like manner, which is a disadvantage in the reduction of an area and power consumption.

As a possible solution, an instruction execution memory (RAM) shared by a plurality of processors is provided so as to divide accesses from the respective processors in a timing-sharing manner using a memory controller or the like. In the case where the instruction execution memory (RAM) is shared, a leading address used when each processor reads the boot program has to be fixed. As a result, it may be obstructed to arbitrarily change a program which is designed to realize a complicated function or efficiently utilize the shared instruction execution memory (RAM).

### SUMMARY OF THE INVENTION

Therefore, a main object of the present invention is to provide a multiprocessing device capable of efficiently utilizing an instruction execution memory.

A multiprocessing device according to the present invention comprises:

a plurality of processors including a specific processor and the other processors;

an instruction storage memory in which instructions executed by the plurality of processors are stored;

an instruction execution memory in which the instructions stored in and transferred from the instruction storage memory are retained, and from which, when an instruction is executed by one of the plurality of processors, a required instruction is retrieved by the processor; and

an address storage memory in which a leading address of a position where the required instruction of the other processors is retained in the instruction execution memory is stored; and

a memory control circuit for coordinating access to the instruction execution memory by the plurality of processors and controlling access to the address storage memory by the specific processor.

In the constitution described above, the specific processor reads the instruction from the instruction storage memory and initializes itself, and transfers the instruction of the other processors from the instruction storage memory to the instruction execution memory via the memory control circuit. Further, the specific processor writes the leading address of the position where the required instruction of the other processors transferred to the instruction execution memory is retained (transfer destination address) in the address storage memory. The other processors access the instruction execution memory via the memory control circuit in accordance with the leading address of the position where the required instruction read from the address storage memory is retained, read the instruction from the instruction execution memory, and start their operation.

According to the present invention, since each of the processors is provided with an address storage memory in which the leading address of the retaining position of a required instruction is stored, the other processors can access the instruction execution memory in accordance with the leading address of the retaining position of the required instruction. Therefore, the instruction execution memory can be shared by the plurality of processors. In other words, it becomes unnecessary to provide the instruction execution memory for each of the processors. As a result, an area of the device can be reduced.

Furthermore, at the time of a program change which requires an increase or a decrease of a program size, the leading address of the retaining position of the required instruction can be set for each of the processors. Therefore, there are no restrictions as to a program size, and the memory can be efficiently utilized.

In the present invention, the specific processor may set the leading address for each of the plurality of processors and store the set leading address in the address storage memory, when the system is powered on or restarted. Accordingly, the leading address of the instruction can be automatically set in the address storage memory for each of the processors in conjunction with the power-up and the restart of the system.

In the present invention, a reset control circuit for controlling the reset of the operation of each of the plurality of processors may be further provided. Accordingly, each of the processors can be arbitrarily reset as necessary.

In the present invention, the reset control circuit may control the reset release of the operation of each of the plurality of processors. Accordingly, the reset of the operation of each processor is arbitrarily released as necessary so as to start the operation.

In the present invention, the specific processor may set the leading address for each of the plurality of processors and store the set leading address in the address storage memory, and

the reset control circuit may control the reset release of the operation of each of the plurality of processors after the leading address is set for each of the plurality of processors.

This constitution can flexibly respond to application change, and the operation can be realized with power which is optimal for each of the applications.

An information processing device according to the present invention comprises

a data generator for generating data; and

the multiprocessing device according to the present invention for processing the data.

According to the present invention, each processor can access the instruction execution memory in accordance with the leading address of the instruction in the address storage memory provided for each processor. As a result, the instruction execution memory can be shared by the plurality of processors, which leads to area reduction.

At the time of a program change which requires an increase or a decrease of a program size, since the leading address of the retaining position in the instruction execution memory can be set for each of the processors, there are no restrictions as to a program size, and the memory can be efficiently utilized.

Furthermore, the plurality of processors can be separately reset-controlled. Therefore, in the case where it is unnecessary for the plurality of processors to be operated in an application, the reset can be kept unleased (not operated). According to the constitution, therefore, the operation can be realized with power which is optimal for each of different applications.

The multiprocessing device according to the present invention is useful to a mobile device, typical examples of which are a mobile telephone, a digital still camera and the like. The multiprocessing device is also applicable to an information processing device including stationary devices such as a DVD device and a television.

### BRIEF DESCRIPTION OF THE DRAWINGS

These and other objects of the invention will become clear by the following description of preferred embodiments of the invention and be specified in the claims attached hereto. A number of benefits not recited in this specification will come to the attention of the skilled in the art upon the implementation of the present invention.

FIG. 1 is a block diagram illustrating a constitution of a multiprocessing device according to a preferred embodiment 1 of the present invention.

FIG. 2 illustrates the allocation of memory in an instruction storage memory according to the preferred embodiment 1.

FIG. 3 illustrates the allocation of memory in an instruction execution memory according to the preferred embodiment 1.

FIG. 4 is a block diagram illustrating a constitution of a multiprocessing device according to a preferred embodiment 2 of the present invention.

FIG. 5 is a flow chart illustrating the activation of processors according to the preferred embodiment 2.

FIG. 6 illustrates a schematic constitution of an imaging device according to a preferred embodiment 3 of the present invention.

FIG. 7 is a block diagram illustrating a constitution of a multiprocessing device according to a conventionally technology.

### DETAILED DESCRIPTION OF THE INVENTION

Hereinafter, preferred embodiments of a multiprocessing device according to the present invention are described in detail referring to the drawings.

### Preferred Embodiment 1

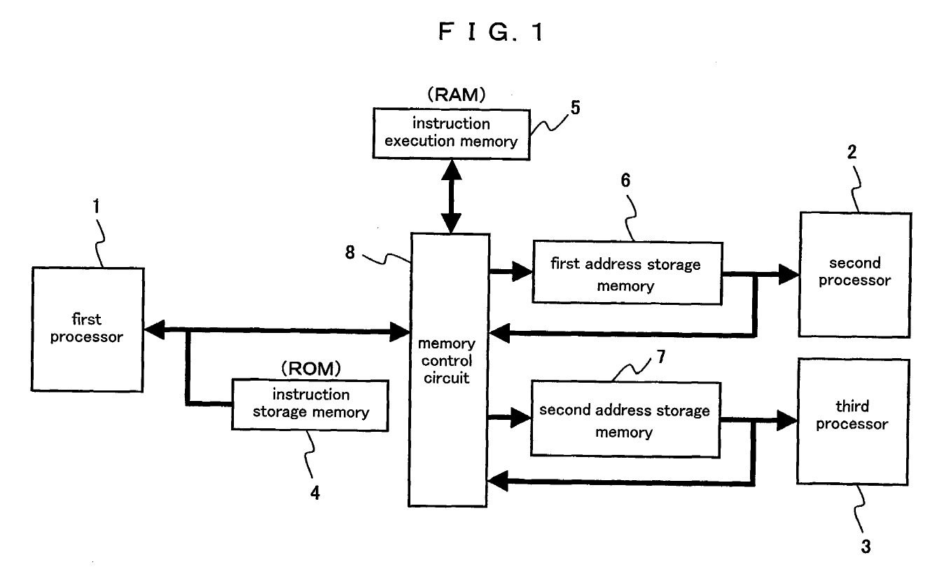

A multiprocessing device according to a preferred embodiment 1 of the present invention is constituted, for example, as illustrated in FIG. 1. The multiprocessing device comprises a first processor 1, a second processor 2, a third processor 3, an instruction storage memory (ROM) 4, an instruction execution memory (RAM) 5, a first address storage memory 6, a second address storage memory 7, and a memory control circuit 8. The instruction storage memory (ROM) 4 memorizes instructions of the first, second and third processors 1, 2 and 3. The instruction execution memory (RAM) 5 stores therein instructions executed by the first, second and third processors 1, 2 and 3. The first address memory 6 stores therein a leading address of the instruction of the second processor 2. The second address memory 7 stores therein a leading address of the instruction of the third processor 3. The memory control circuit 8 controls the access to the instruction execution memory 5 by the first, second and third processors 1, 2 and 3, and the access to the first and second address storage memories 6 and 7 by the first processor 1. In the present preferred embodiment, the first, second and third processors 1, 2 and 3 correspond to a plurality of processors. The first processor 1 corresponds to a specific processor, while the second and third processors 2 and 3 correspond to the other processors.

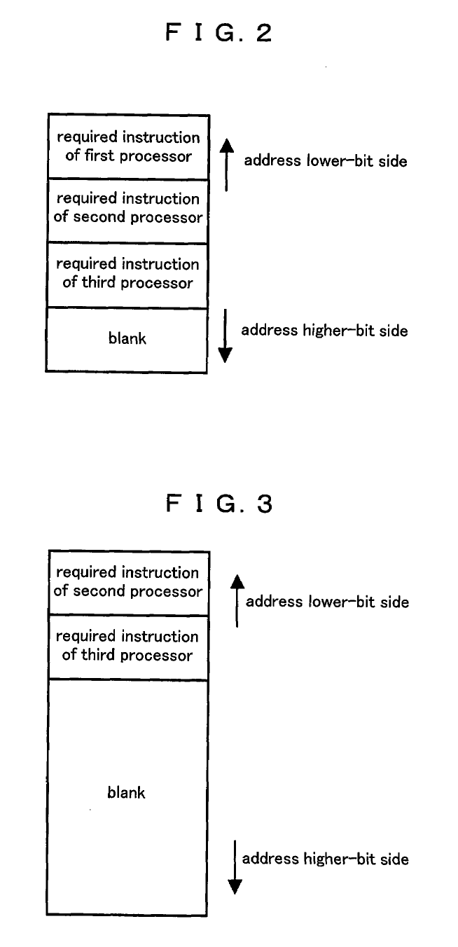

In the multiprocessing device thus constituted, the first processor 1 reads a required instruction from the instruction storage memory 4 when activated, and initializes itself. In the data of the instruction storage memory 4, for example, the required instructions of the first, second and third processors 1, 2 and 3 are memorized in that order as illustrated in FIG. 2. Therefore, the first processor 1 can initialize itself by reading the required instruction from the top of the instruction storage memory 4. After the initialization, the first processor 1 reads the required instructions of the second and third processors 2 and 3 from the instruction storage memory 4 and transfers them to the instruction execution memory 5 via the memory control circuit 8. Further, the first processor 1 writes the transfer destination address (leading address of retaining position) of the required instruction of the second processor 2 transferred to the instruction execution memory 5 in the first address storage memory 6, and writes the transfer destination address (leading address of retaining position) of the required instruction of the third processor 3 transferred to the instruction execution memory 5 in the second address storage memory 7.

In the data of the instruction execution memory 5, the required instructions of the second and third processors 3 are written in that order as illustrated in FIG. 3. The addresses at which instructions are written are not in a constant form because the number of the instructions and the data size are not constant and are subject to change. In FIG. 3, the required instruction of the second processor 2 is at the top of the instruction execution memory 5; however, it may not be necessarily so.

When the processing of the first processor 1 (the required instructions of the second and third processors 2 and 3 are transferred and written in the address storage memories 6 and 7) is completed, the second and third processors 2 and 3 reads the respective required instructions from the instruction execution memory 5 via the memory control circuit 8 and start their operations.

The instruction storage memory 4 is a memory device which can retain data even during no power supply, while the instruction execution memory 5 is a memory which cannot retain data during no power supply. Examples of the instruction storage memory 4 are a mask ROM, a flash ROM, a hard disk device, CD-ROM, DVD-ROM, DVD-RAM and the like, and an access rate thereof is generally slow. SDRAM (Synchronous DRAM) and DDR-SDRAM (Double Data Rate SDRAM) are used as the instruction execution memory 5, which can access the instruction storage memory 4 at a high rate.

Memory sizes of the first and second storage memories 6 and 7 depend on address lengths used by the second and third processors 2 and 3, and are generally at most 64 bits, which are very small in comparison to the sizes of the instruction storage memory 4 and the instruction execution memory 5. Thus, power consumed for those memories is a very small amount. Therefore, the area reduction and power reduction in the whole device are hardly adversely affected by those memories.

The memory control circuit 8 sequentially processes the access to the instruction execution memory 5 by the first, second, and third processors 1, 2 and 3 in a time-sharing manner. In the case where the access is tried from two processors at the same time, the processor with a higher priority is allowed to access the memory, while the processor with a lower priority has to wait to access the memory until the processor with a higher priority completes its access. In the case where a processor tries to access the memory while another processor is accessing the memory, the processor which tried to access the memory has to wait. The respective processors access the instruction execution memory 5 when they read the required instructions. However, the instruction execution memory 5 is not always accessed, and therefore, the plurality of processors can be connected thereto. The memory control circuit 8 controls the write by the first processor 1 with respect to the first address storage memory 6 and the write by the first processor 1 with respect to the second address storage memory 7.

In the foregoing constitution, the instruction execution memory 5 is shared by the plurality of processors. Therefore, it is unnecessary to provide the instruction execution memory for each of the plurality of processors, and the plurality of processors can be operated with one common memory. Further, when the program is changed and the program size is thereby increased or decreased, the leading address of the instruction can be easily changed. Therefore, there are no restrictions as to a program size, and the memory can be efficiently utilized.

The required instruction of the first processor 1, which is not transferred to the instruction execution memory 5 in the present preferred embodiment, may also be transferred to the instruction execution memory 5.

In the preferred embodiment 1, the multiprocessing device comprising three processors was described; however, two processors or four or more processors can constitute the multiprocessing device in a similar manner.

### Preferred Embodiment 2

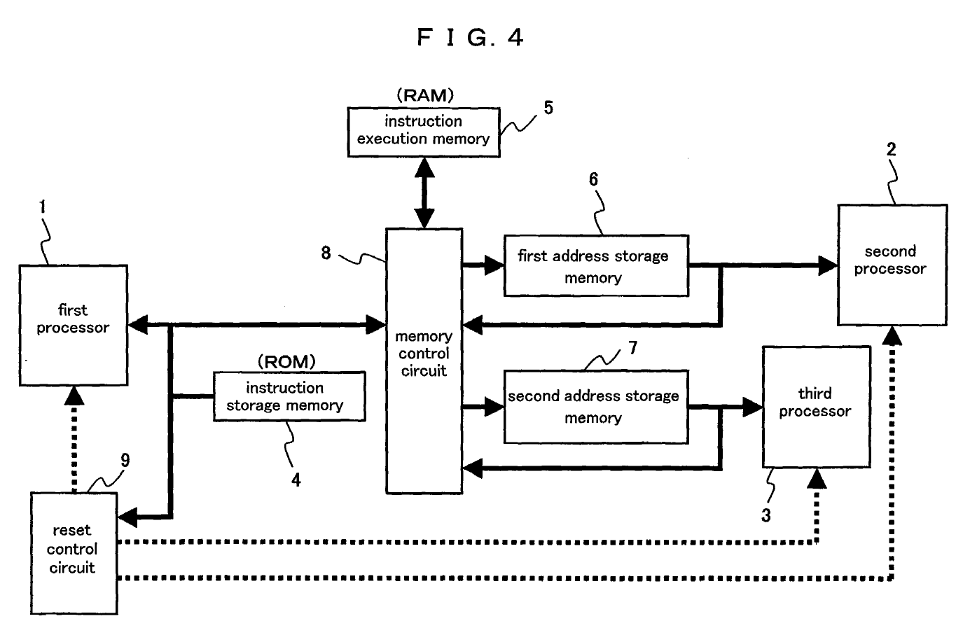

A multiprocessing device according to a preferred embodiment 2 of the present invention is constituted, for example, as illustrated in FIG. 4. In FIG. 4, the same reference symbols as those shown in FIG. 1 for the preferred embodiment 1 denote the same components. The constitution according to the present preferred embodiment is characterized in that a reset control circuit 9 which controls a reset signal of the first processor 1, a reset signal of the second processor 2 and a reset signal of the third processor 3 is provided. The description of the rest of the constitution, which is similar to that of the preferred embodiment 1, is omitted.

In the multiprocessing device thus constituted, the rest of the first processor 1 is released by the reset control circuit 9, and the operation of the first processor starts. The first processor 1 reads its required instruction from the instruction storage memory 4 and initializes itself.

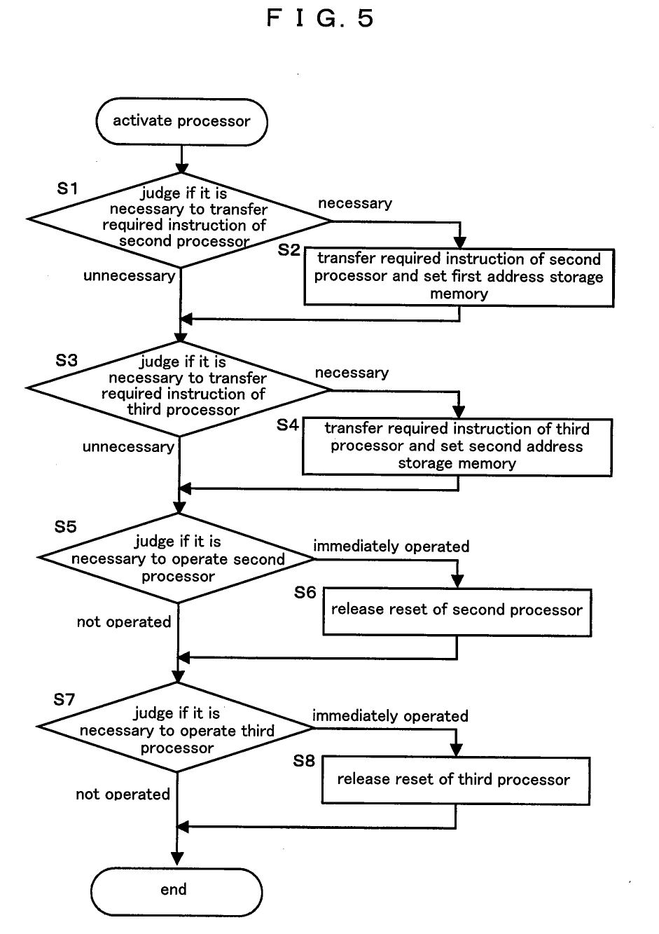

The first processor 1, after its initialization, activates the second and third processors 2 and 3 as illustrated in a flow chart of FIG. 5. The first processor 1 judges whether or not it is necessary to transfer the required instruction of the second processor 2 (S1). When judged that it is necessary, the first processor 1 reads the required instruction of the second processor 2 from the instruction storage memory 4 and transfers it to the instruction execution memory 5 via the memory control circuit 8. The first processor 8 writes the transfer destination address (leading address of retaining position) of the required instruction of the second processor 2 transferred to the instruction execution memory 5 in the first address storage memory 6 (S2).

Next, the first processor judges whether or not it is necessary to transfer the required instruction of the third processor 3 (S3). When judged that it is necessary, the first processor 1 reads the required instruction of the third processor 3 from the instruction storage memory 4 and transfers it to the instruction execution memory 5 via the memory control circuit 8. The first processor 1 writes the transfer destination address (leading address of retaining position) of the required instruction of the third processor 3 transferred to the instruction execution memory 5 in the second address storage memory 7 (S4).

Then, the first processor 1 judges whether or not it is necessary to operate the second processor 2 (S5). When judged that it is necessary, the first processor 1 releases the reset of the second processor 2 by controlling the reset control circuit 9. Accordingly, the second processor 2 reads its required instruction from the instruction execution memory 5 via the memory control circuit 8 and starts its operation (S6).

Then, the first processor 1 judges whether or not it is necessary to operate the third processor 3 (S7). When judged that it is necessary, the first processor 1 releases the reset of the third processor 3 by controlling the reset control circuit 9. Accordingly, the third processor 3 reads its required instruction from the instruction execution memory 5 via the memory control circuit 8 and starts its operation (S8).

The timings by which the reset of the second and third processors 2 and 3 is released are not necessarily as described earlier. The reset can be released at an arbitrary required timing anytime after the completion of the transfer of the instruction to the instruction execution memory 5 and the write of the instruction in the first or second address storage memory 6 or 7.

According to the foregoing constitution, in the case where it is unnecessary to operate any of the processors in the multiprocessing device comprising the plurality of processors, the following are made possible:
the reset is maintained so that the processor is not operated; and
the reset of the processor is released at a required timing.

As a result, the operation with power optimal for different applications can be realized.

In the preferred embodiment 2, the multiprocessing device comprising three processors was described; however, two processors or four or more processors can constitute the multiprocessing device in a similar manner.

### Preferred Embodiment 3

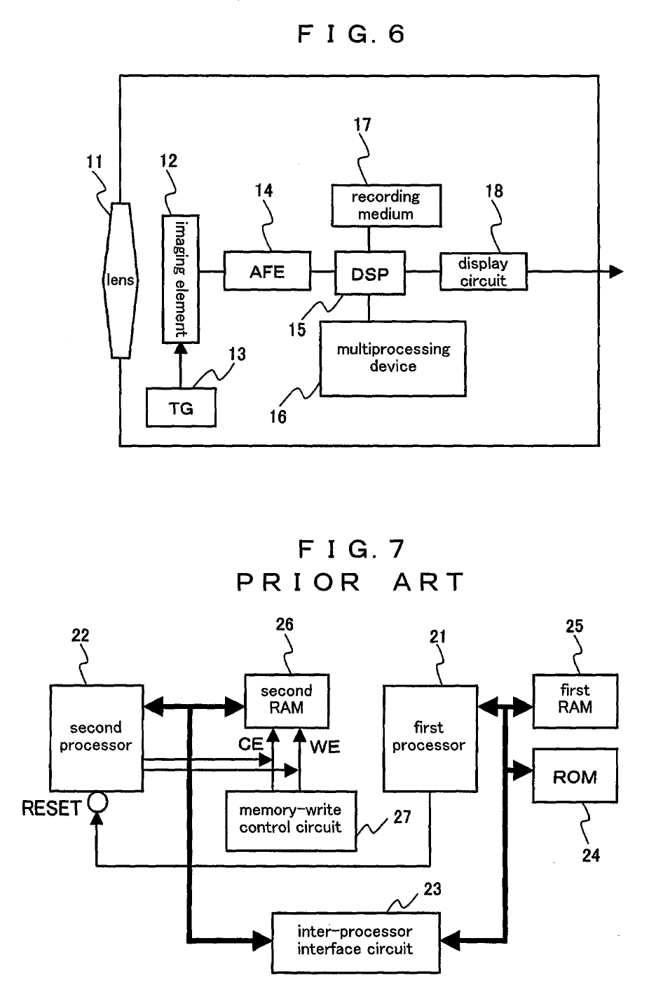

FIG. 6 is an illustration of an imaging device which is an example of the information processing device to which the multiprocessing device according to the preferred embodiment is applied. The imaging device illustrated in FIG. 6 comprises a lens 11 which image-forms an optical image of an object on an imaging element, an imaging element 12 which converts the optical image into an electrical signal, a timing generator (TG) 13 which sets a drive timing of the imaging element 12, an analog front end (AFE) 14 provided with a correlated double sampling circuit which executes correlated double sampling to the electrical signal and an A/D converting circuit which converts the analog signal (electrical signal) into a digital signal, a DSP (Digital Signal Processor) 15 which signal-processes the digital signal, a multiprocessing device 16 according to the preferred embodiment 1 (FIG. 1) or the preferred embodiment 2 (FIG. 4) which data-processes the signal-processed digital signal, a recording medium 17 on which the recorded data is written, and a display circuit 18 which displays the data on a television or LCD (Liquid Crystal Display) In the present preferred embodiment, the imaging element 12, timing generator (TG) 13, analog front end (AFE) 14, and DSP (Digital Signal Processor) 15 constitute a data generator.

In the imaging device thus constituted, an output signal (video signal) of the imaging element 12 is inputted to the DSP 15 via the AFE 14 and signal-processed therein in a recording mode. The video signal signal-processed in the DSP 15 is outputted to the display circuit 18. The resulting video signal is processed into data to be recorded in the DSP 15 and outputted to and recorded on the recording medium 17.

The multiprocessing device 16 controls the system and also executes audio processing and the like. Therefore, in the multiprocessing device 16, a plurality of processors provided therein are operated. In a mode where a still image is reproduced, video data for one page is read from the recording medium 17 and display-processed in the DSP 15, and then outputted to the display circuit 18. In that case, the multiprocessing device 16 does not need to execute any processing except controlling the system. Therefore, it is unnecessary for the plurality of processors to be operated and it is unnecessary for all of the plurality of processors provided therein to be operated.

When the operation of the multiprocessing device provided in the imaging device is changed depending on the modes according to the method recited in the preferred embodiment 2, the operation can be realized with optimal power.

In the case where the multiprocessing device 16 is applied to a mobile telephone, any complicate processing is unnecessary in a standby position. Therefore, all of the plurality of processors provided therein do not need to be operated. In the case of reproducing music, playing a game or the like, however, the system is changed depending on processing complexity according to the method recited in the preferred embodiment 2 so that the plurality of processors are operated. As a result, the operation can be realized with optimal power.

In the case where the multiprocessing device 16 is applied to, for example, a DVD recording/reproduction device, a processing volume of the processors is increased at the time of recording in comparison with at the time of reproduction because it is necessary to process inputted information. Even in such a case, the operation can be realized with optimal power when the operation of the multiprocessing device is changed according to the method recited in the preferred embodiment 2.

In the preferred embodiment 3, the application of the multiprocessing device 16 to the imaging device, mobile telephone and DVD recording/reproducing device was described. The multiprocessing device, however, can be applied to any information processing device in which a multiprocessor is provided.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A multiprocessing device comprising:
a plurality of processors including a specific processor and the other processors;
an instruction storage memory in which instructions executed by the plurality of processors are stored;
an instruction execution memory in which the instructions stored in and transferred from the instruction storage memory are retained, and from which, when an instruction is executed by one of the plurality of processors, a required instruction is retrieved by the processor; and
an address storage memory in which a leading address of a position where the required instruction of the other processors is retained in the instruction execution memory is stored; and
a memory control circuit for coordinating access to the instruction execution memory by the plurality of processors and controlling access to the address storage memory by the specific processor.

2. The multiprocessing device as claimed in claim 1, wherein
the specific processor sets the leading address for each of the plurality of processors and stores the set leading address in the address storage memory, when a system is powered on or restarted.

3. The multiprocessing device as claimed in claim 1, further comprising a reset control circuit for controlling the reset of the operation of each of the plurality of processors.

4. The multiprocessing device as claimed in claim 3, wherein
the reset control circuit controls the reset release of the operation of each of the plurality of processors.

5. The multiprocessing device as claimed in claim 3, wherein
the specific processor sets the leading address for each of the plurality of processors and stores the set leading address in the address storage memory, and
the reset control circuit controls the reset release of the operation of each of the plurality of processors after the leading address is set for each of the plurality of processors.

6. An information processing device comprising:
a data generator for generating data; and
the multiprocessing device as claimed in claim 1 for processing data.

7. An imaging device comprising:
an imaging element for converting an optical image of an object into an electrical signal;
a timing generator for setting a drive timing of the imaging element;
an analog front end provided with a correlated double sampling circuit for executing correlated double sampling to the electrical signal and an A/D converting circuit for converting the electrical signal which was subjected to the correlated double sampling into a digital signal;
a digital signal processor for signal-processing the digital signal; and
the multiprocessing device as claimed in claim 1 for data-processing the signal-processed digital signal.
